(19) United States
(12) Patent Application Publication
(10) Pub. No.: US 2012/0099031 A1
(43) Pub. Date: Apr. 26, 2012

(54) PROJECTOR AND OPTICAL UNIT

(75) Inventors: Yusuke Kinoe, Suwa-shi (JP); Takafumi Goto, Nabari-shi (JP)

(73) Assignee: Seiko Epson Corporation, Tokyo (JP)

(21) Appl. No.: 13/240,811

(22) Filed: Sep. 22, 2011

(30) Foreign Application Priority Data
Oct. 26, 2010 (JP) 2010-239333
Apr. 21, 2011 (JP) 2011-094776

(51) Int. Cl. G02F 1/13357

(52) U.S. Cl. 349/8

(57) ABSTRACT

A projector includes a plurality of reflective liquid crystal panels (for example, a red liquid crystal panel, a green liquid crystal panel, and a blue liquid crystal panel). The film thickness of an ITO film that forms a common electrode of the blue liquid crystal panel is smaller than the film thickness of an ITO film that forms a common electrode of any one of the red liquid crystal panel and the green liquid crystal panel. The film thicknesses of the ITO films that form the common electrodes of the red liquid crystal panel and the green liquid crystal panel are the same.

Japanese Patent Applications No. 2010-239333, filed Oct. 26, 2010 and No. 2011-094776, filed Apr. 21, 2011 are incorporated by reference in its entirety herein.

### BACKGROUND

1. Technical Field

The present invention relates to a projector and an optical unit, each of which including a plurality of liquid crystal panels.

2. Related Art

There are projectors including a plurality of liquid crystal panels that function as light valves. In such projectors, light emitted from a light source unit is split into color light beams, the liquid crystal panels modulate the color light beams, which are then combined with each other, and a projection optical system projects the combined light onto a viewing surface such as a screen. The liquid crystal panels are constituted by a red liquid crystal panel to which a red light beam is supplied, a green liquid crystal panel to which a green light beam is supplied, and a blue liquid crystal panel to which a blue light beam is supplied.

Reflective liquid crystal panels may be used as light valves in such a projector. In this case, each of the reflective liquid crystal panels includes a first substrate, a second substrate, and a liquid crystal layer between the first and second substrates. The first substrate includes reflective pixel electrodes formed on a side thereof. The second substrate is light transmissive and includes a common electrode, which is light transmissive, formed on a side of the second substrate that faces the side of the first substrate. In general, all the reflective liquid crystals include the first substrates, the second substrates, and the liquid crystal layers that respectively have the same structure.

However, the blue liquid crystal panel deteriorates relatively rapidly because it is supplied with a light beam having a relatively short wavelength. For this reason, an alignment film and a liquid crystal material that are different from those for other liquid crystal panels may be used for the blue liquid crystal panel (see JP-A-2009-31545).

A technology for increasing the light efficiency of a projector that displays an image in a scattering mode by using scattering liquid crystal panels has been proposed. In this technology, the optical thickness of a common electrode of each of the liquid crystal panel is set at about half the center wavelength of a light beam that the liquid crystal panel modulates (see JP-A-11-133447).

### SUMMARY

A liquid crystal panel used in a projector has spectral reflection characteristics such that the reflectance periodically increases and decreases with the frequency in correspondence with the optical thickness of a common electrode or the like. Therefore, when an image is displayed by using a red liquid crystal panel, a green liquid crystal panel, and a blue liquid crystal panel, if there is an in-plane variation in the distance between the first substrate and the second substrate (i.e., the thickness of the liquid crystal layer), the degree of modulation may vary from pixel to pixel due to the in-plane variation in retardation of the liquid crystal layer, so that a problem arises in that the hue of blue color, which corresponds to a light beam having the shortest wavelength, may become nonuniform. However, such a problem and measures against the problem are not described in JP-A-2009-31545 and JP-A-11-133447.

An advantage of some aspects of the invention is that a projector and an optical unit are provided that are capable of effectively preventing a nonuniform hue that may occur due to an in-plane variation in the thicknesses of liquid crystal layers of liquid crystal panels corresponding to light beams in different wavelength ranges.

According to a first aspect of the invention, a projector includes a light source unit, three or more liquid crystal panels, and a projection optical system. The three or more liquid crystal panels each include a first substrate, a second substrate, and a liquid crystal layer between the first and second substrates. The first substrate includes reflective pixel electrodes formed on a side thereof. The second substrate is light-transmissive and includes a common electrode formed on a side thereof facing the side of the first substrate. The common electrode is light-transmissive. Each of the three or more liquid crystal panels is supplied with a light beam emitted from the light source unit, the light beams being in different wavelength ranges. The projection optical system projects light generated by combining the light beams modulated by the three or more liquid crystal panels. The common electrode of a short-wavelength liquid crystal panel, the short-wavelength liquid crystal panel being one of the three or more liquid crystal panels that modulates a light beam in a shortest wavelength range among the three or more liquid crystal panels, has a film thickness that is smaller than a film thickness of the common electrode of any one of the other liquid crystal panels. The film thicknesses of the common electrodes of the other liquid crystal panels are the same.

In this case, the film thickness of the common electrode of the short-wavelength liquid crystal panel, which is one of the liquid crystal panels that modulates a light beam in the shortest wavelength range, is smaller than the film thickness of the common electrode of any one of the other liquid crystal panels, and the optical film thickness is optimized. Therefore, even if the reflectance of the short-wavelength liquid crystal panel increases and decreases with the frequency, the variation range is small. Accordingly, even if there is an in-plane variation in the distance between the first substrate and the second substrate (the layer thickness of the liquid crystal layer) of the short-wavelength liquid crystal panel and the degree of modulation of light varies from pixel to pixel, variation in the amount of light emitted via the short-wavelength liquid crystal panel is small among pixels that are supposed to have the same gradation. As a result, generation of a nonuniform hue due to the in-plane variation in the distance between the first substrate and the second substrate of the short wavelength liquid crystal panel can be prevented. In the first aspect of the invention, the optical film thickness of the common electrode of the short-wavelength liquid crystal panel, which modulates a light beam having a short wavelength, is optimized because the nonuniform hue is easily generated. In contrast, the optical film thicknesses of the common electrodes of the other liquid crystal panels, which modulate light beams having relatively long wavelengths, are made the same because a nonuniform hue is not easily generated. Therefore, the same liquid crystal panels may be used as the other liquid crystal panels, whereby generation of a nonuniform hue is prevented while suppressing an increase in the manufacturing cost, as compared with the case where the optical film thickness of the common electrode of each of the liquid crystal panels is optimized. Because the common electrode is made of an indium tin oxide (ITO) film or the like and has an refractive index that is higher than those of other layers, the spectral reflection characteristics of the liquid crystal panel can be effectively optimized by adjusting the film thickness of the common electrode.

It is preferable that the short-wavelength liquid crystal panel have spectral reflection characteristics such that the difference between a maximum reflectance and a minimum reflectance in the shortest wavelength range, which is the wavelength range of the light beam that the short-wavelength liquid crystal panel modulates, is smaller than the difference between a maximum reflectance and a minimum reflectance in a range of wavelength that is longer than wavelength of the shortest wavelength range, the spectral reflection characteristics representing the relationship between the wavelength of a light beam supplied to the liquid crystal panel and the reflectance of the liquid crystal panel. It is difficult to reduce the variation in reflectance in the spectral reflection characteristics for all wavelength ranges. However, the occurrence of nonuniform hue is prevented by reducing the variation in the wavelength range of a light beam that the short-wavelength liquid crystal panel modulates. Variation in the reflectance in a specific wavelength range can be reduced relatively easily by optimizing the thickness of the common electrode.

It is preferable that the film thickness of the common electrode of the short-wavelength liquid crystal panel be in a range of 0.70 to 0.90 times the film thickness of the common electrodes of the other liquid crystal panels. With consideration of the wavelength dependency of the refractive index of the common electrodes, the optical film thicknesses of the common electrodes of the short-wavelength liquid crystal panel and the other liquid crystal panels can be substantially optimized by setting the film thicknesses of the common electrodes in the range described above.

It is preferable that the optical film thickness of the short-wavelength liquid crystal panel at the center wavelength of the shortest wavelength range, which is the wavelength range of the light beam that the short-wavelength liquid crystal panel modulates, be about half the center wavelength, the optical film thickness being the product of a refractive index of the common electrode and the film thickness of the common electrode of the short-wavelength liquid crystal panel. In this case, the optical film thickness of the common electrode is optimized. Therefore, occurrence of a nonuniform hue in a projected image of a light beam that the short-wavelength liquid crystal panel modulates is reliably prevented.

It is preferable that the optical film thickness of one of the other liquid crystal panels, the one of the other liquid crystal panels modulating a light beam having a shorter wavelength among the other liquid crystal panels, at the center wavelength of the wavelength range of the light beam that the one of the other liquid crystal panels modulates be about half the center wavelength, the optical film thickness being the product of the refractive index of the common electrode and the film thickness of the common electrode of the one of the other liquid crystal panels. In this case, even if the film thicknesses of the common electrodes of the other liquid crystal panels are the same, the optical film thickness of the common electrode of one of the other liquid crystal panels that modulates a light beam having a shorter wavelength is optimized. Therefore, occurrence of a nonuniform hue in a projected image of a light beam that the liquid crystal panel modulates is reliably prevented.

It is preferable that the common electrode of the short-wavelength liquid crystal panel have spectral transmission characteristics such that a peak transmittance is located in the wavelength range of the light beam that the short-wavelength liquid crystal panel modulates, the spectral transmission characteristics representing the relationship between the wavelength of a light beam supplied to the common electrode and the transmittance of the common electrode.

It is preferable that the common electrodes of the three or more liquid crystal panels be ITO films. If the common electrodes are made of ITO films, the indices of refraction of the common electrodes are higher than those of other layers. Therefore, the spectral reflection characteristics of the liquid crystal panels can be optimized by only adjusting the film thicknesses of the common electrodes.

It is preferable that the liquid crystal panels be a red liquid crystal panel to which a red light beam is supplied, a green liquid crystal panel to which a green light beam is supplied, and a blue liquid crystal panel to which a blue light beam is supplied, the blue liquid crystal panel be the short-wavelength liquid crystal panel including the common electrode that has a film thickness smaller than those of the common electrodes of the red liquid crystal panel and the green liquid crystal panel, and the red liquid crystal panel and the green liquid crystal panel be the other liquid crystal panels including the common electrodes having the same film thickness.

An optical unit may include liquid crystal panels and a light combining optical system. According to a second aspect of the invention, an optical unit includes three or more liquid crystal panels and a light-combining optical system. The three or more liquid crystal panels each include a first substrate, a second substrate, and a liquid crystal layer between the first and second substrates. The first substrate includes reflective pixel electrodes formed on a side thereof. The second substrate is light-transmissive and includes a common electrode formed on a side thereof facing the side of the first substrate. The common electrode is light-transmissive. Each of the three or more liquid crystal panels is supplied with a light beam, the light beams being in different wavelength ranges. The light-combining optical system emits light generated by combining light beams emitted from the three or more liquid crystal panels. The common electrode of a short-wavelength liquid crystal panel, the short-wavelength liquid crystal panel being one of the three or more liquid crystal panels that modulates a light beam in a shortest wavelength range among the three or more liquid crystal panels, has a film thickness that is smaller than a film thickness of the common electrode of any one of the other liquid crystal panels. The film thicknesses of the common electrodes of the other liquid crystal panels are the same.

### BRIEF DESCRIPTION OF THE DRAWINGS

The invention will be described with reference to the accompanying drawings, wherein like numbers reference like elements.

FIG. 1 illustrates a projector according to an embodiment of the invention.

FIGS. 2A and 2B illustrate a liquid crystal panel of the projector according to the embodiment of the invention.

FIG. 3 is a plan view illustrating a pixel of the liquid crystal panel of the projector according to the embodiment of the invention.

FIGS. 4A and 4B are sectional views illustrating the pixel of the liquid crystal panel of the projector according to the embodiment of the invention.

FIG. 5 is a graph illustrating the relationship between the refractive index of an ITO film and the wavelength, the ITO film being used as a common electrode of the liquid crystal panel of the projector according to the embodiment of the invention.

FIG. 6 is a graph illustrating a comparison of the spectral transmission characteristics of the common electrode of a short-wavelength liquid crystal panel (a blue liquid crystal panel) and the common electrodes of other liquid crystal panels (a red liquid crystal panel and a green liquid crystal panel) of the projector according to the embodiment of the invention.

FIG. 7 is a graph illustrating a comparison of the spectral reflection characteristics of the short-wavelength liquid crystal panel (the blue liquid crystal panel) and the other liquid crystal panels (the red liquid crystal panel and the green liquid crystal panel) of the projector according to the embodiment of the invention.

### DESCRIPTION OF EXEMPLARY EMBODIMENTS

Embodiments of the invention will be described with reference to the drawings. Layers and components are shown in different scales in the drawings so as to make them visible. Liquid crystal panels, which function as light valves, will be referred to as liquid crystal panels 100 when describing the structure and the like that are common to all the liquid crystal panels. When describing the structure of a specific one of the liquid crystal panels 100, the liquid crystal panel will be referred to as a red liquid crystal panel 100R, a green liquid crystal panel 100G, or a blue liquid crystal panel 100B by adding R (red), G (green), or B (blue) in accordance with the wavelength range of a light beam that the liquid crystal panel modulates. The wavelength ranges of a red light beam, a green light beam, and a blue light beam are assumed to be 620 to 740 nm, 500 to 570 nm, and 430 to 500 nm, respectively.

### Exemplary Structure of Projector

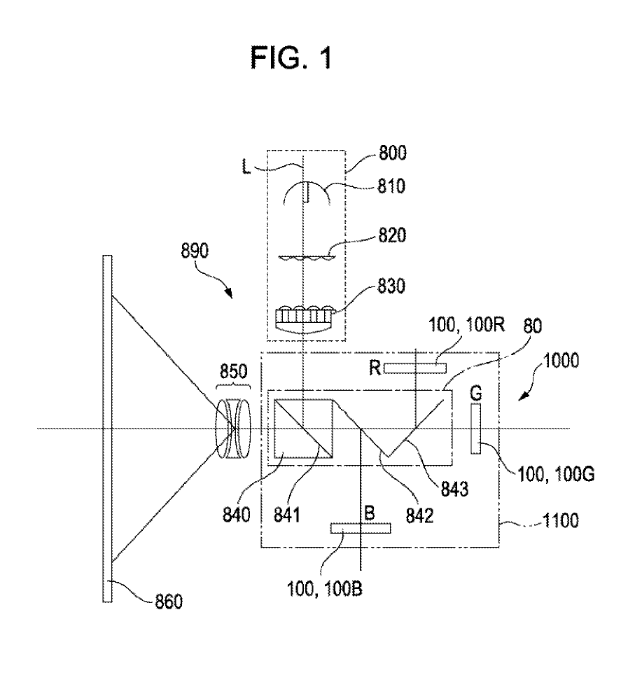

FIG. 1 illustrates a projector 1000 according to an embodiment of the invention. The projector 1000 includes a light source unit 890 including a polarizing illumination device 800. The polarizing illumination device 800 includes a light source 810, an integrator lens 820, and a polarization conversion element 830, which are arranged along a system optical axis L. The light source unit 890 further includes a polarizing beam splitter 840 that reflects an s-polarized light beam, which is emitted from the polarizing illumination device 800, along the system optical axis L by using an s-polarized light beam reflecting surface 841. The light source unit 890 further includes a dichroic mirror 842 and a dichroic mirror 843. The dichroic mirror 842 separates a blue (B) light component from the light beam reflected by the s-polarized light beam reflecting surface 841 of the polarizing beam splitter 840. The dichroic mirror 843 separates a red (R) light component from the light beam from which the blue light component has been separated. In the projector 1000, the liquid crystal panels 100, the dichroic mirrors 842 and 843, and the polarizing beam splitter 840 constitute an optical unit 1100. The dichroic mirrors 842 and 843 constitute a light combining optical system 80.

The projector 1000 includes three reflective liquid crystal panels 100 (the red liquid crystal panel 100R, the green liquid crystal panel 100G, and the blue liquid crystal panel 100B), into which corresponding color light beams are supplied. The light source unit 890 supplies predetermined color light beams to the three liquid crystal panels 100.

To be specific, a red light beam in the wavelength range of 620 to 740 nm (center wavelength of 680 nm) is supplied to the red liquid crystal panel 100R, a green light beam in the wavelength range of 500 to 570 nm (center wavelength of 535 nm) is supplied to the green liquid crystal panel 100G, and a blue light beam in the wavelength range of 430 to 500 nm (center wavelength of 465 nm) is supplied to the blue liquid crystal panel 100B. Therefore, in the present embodiment, the blue liquid crystal panel 100B corresponds to a “short-wavelength liquid crystal panel” that modulates a light beam in the shortest wavelength range, and the red liquid crystal panel 100R and the green liquid crystal panel 100G correspond to “other liquid crystal panels”.

With the projector 1000 having the structure described above, the three liquid crystal panels 100 modulate the light beams, the light combining optical system 80, which includes the dichroic mirrors 842 and 843, combine the light beams, and a projection optical system 850 projects the combined light beam onto a screen 860 or another viewing surface.

### Structure of Liquid Crystal Panel 100

### Overall Structure of Liquid Crystal Panel 100

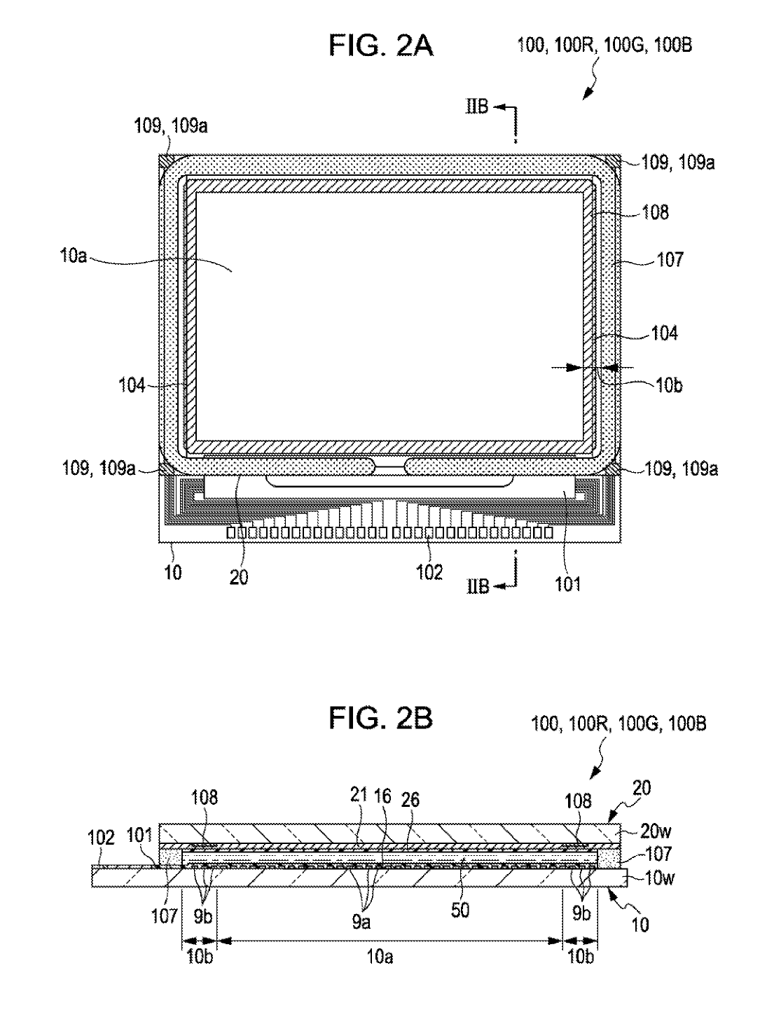

FIGS. 2A and 2B illustrate one of the liquid crystal panels 100 of the projector 1000 according to the embodiment of the invention, FIG. 2A illustrating a plan view of the liquid crystal panel 100 and the components thereof seen from the second substrate side, and FIG. 2B illustrating a sectional view of the liquid crystal panel 100 taken along line IIB-IIB.

As illustrated in FIGS. 2A and 2B, in the liquid crystal panel 100 (the red liquid crystal panel 100R, the green liquid crystal panel 100G, or the blue liquid crystal panel 100B), a first substrate 10 and a second substrate 20 are bonded to each other by a sealing member 107 with a predetermined gap therebetween. The sealing member 107 has a frame-like shape extending along the outer edge of the second substrate 20. The sealing member 107 is an adhesive composed of a photosetting resin, a thermosetting resin, or the like. Spacers, such as glass fibers and glass beads, for separating the first and second substrates 10 and 20 from each other at a predetermined distance are mixed in the adhesive. In the liquid crystal panel 100 having the structure described above, a liquid crystal layer 50 is provided in a region between the first and second substrates 10 and 20 and surrounded by the sealing member 107. In the present embodiment, the first and second substrates 10 and 20 are quadrangular. A pixel region 10a, which is substantially quadrangular, is provided in substantially the center of the liquid crystal panel 100. The sealing member 107 also has a substantially rectangular shape that corresponds to shape of the pixel region 10a. A peripheral region 10b, which is substantially rectangular-frame-shaped, is provided between the inner peripheral edge of the sealing member 107 and the outer peripheral edge of the pixel region 10a. In an area of the first substrate 10 outside the pixel region 10a, a data line driving circuit 101 extends along an edge of the first substrate 10, a plurality of terminals 102 are arranged along the edge, and a scan line driving circuit 104 extends along an edge adjacent to the edge. A flexible circuit board (not shown) is connected to the terminals 102, and various electric potentials are applied and various signals are input to the first substrate 10 via the flexible circuit board.

On a side of the first substrate 10, pixel transistors 30 and pixel electrodes 9a, which are electrically connected to the pixel transistor 30, are formed in the pixel region 10a in a matrix pattern, and an alignment film 16 is formed on the upper side of the pixel electrodes 9a, as described below. Dummy pixel electrodes 9b are formed simultaneously with the pixel electrodes 9a in the peripheral region 10b on the side of the first substrate 10. The dummy pixel electrodes 9b may be electrically connected to dummy pixel transistors, may be directly connected to wiring without using the dummy pixel transistors, or may be configured as float electrodes to which electric potentials are not applied. The dummy pixel electrodes 9b serve to reduce the difference between the height of the pixel region 10a and the height of the peripheral region 10b. This serves to flatten a surface of the first substrate 10 on which the alignment film 16 is to be formed when polishing the surface. By applying a predetermined electric potential to the dummy pixel electrodes 9b, nonuniformity of the alignment of liquid crystal molecules in the outer periphery of the pixel region 10a can be prevented.

A common electrode 21 is formed on a side of the second substrate 20 facing the first substrate 10. The alignment film 26 is formed on the upper side (on a side near the liquid crystal layer 50) of the common electrode 21. The common electrode 21 may be a single electrode extending over substantially the entire surface of the second electrode 20 or may be constituted by a plurality of strip-shaped electrodes that extend over a plurality of pixels 100a. A light-shielding layer 108 is formed on the side of the second substrate 20 facing the first substrate 10 and on the lower side of the common electrode 21. In the present embodiment, the light-shielding layer 108 has a frame-like shape extending along the outer peripheral edge of the pixel region 10a and defines a display area. The outer peripheral edge of the light-shielding layer 108 is separated from the inner peripheral edge of the sealing member 107, so that the light-shielding layer 108 and the sealing member 107 do not overlap. On the second substrate 20, the light-shielding layer 108 may be formed, for example, in a region that overlaps a region between adjacent pixel electrodes 9a.

In the liquid crystal panel 100 having the structure described above, inter-substrate connection electrodes 109, which electrically connect the first substrate 10 to the second substrate 20, are formed on the first substrate 10 in regions that are outside the sealing member 107 and that overlap corners of the second substrate 20. Inter-substrate conductors 109a, which contain electroconductive particles, are disposed in the inter-substrate connection electrodes 109. The common electrode 21 of the second substrate 20 is electrically connected to the first substrate 10 via the inter-substrate conductors 109a and the inter-substrate connection electrodes 109. Therefore, a common electric potential is applied to the common electrode 21 from the first substrate 10.

The sealing member 107 has a substantially constant width and extends along the outer periphery edge of the second substrate 20. Therefore, the sealing member 107 is substantially rectangular. However, the corners of the sealing member 107 are substantially arc-shaped because the sealing member 107 is formed so as not to contact the inter-substrate connection electrodes 109 in regions that overlap the corners of the second substrate 20.

In the liquid crystal panel 100 according to the present embodiment, which has the structure described above, the common electrode 21 is made of a light transmissive electroconductive film and the pixel electrodes 9a are made of a reflective conductive film. In the liquid crystal panel 100, which is of a reflective type, a light beam enters the liquid crystal panel 100 through the second substrate 20, and the light beam is modulated while being reflected by the first substrate 10 toward the outside. In the present embodiment, the liquid crystal panel 100 is a VA-mode liquid crystal panel including the liquid crystal layer 50 composed of a nematic liquid crystal having negative dielectric anisotropy.

### Structure of Pixel

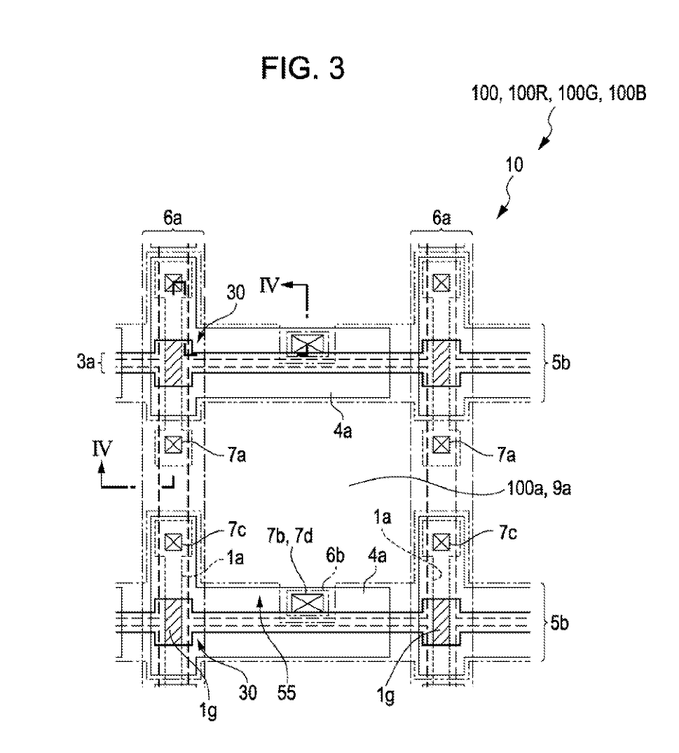

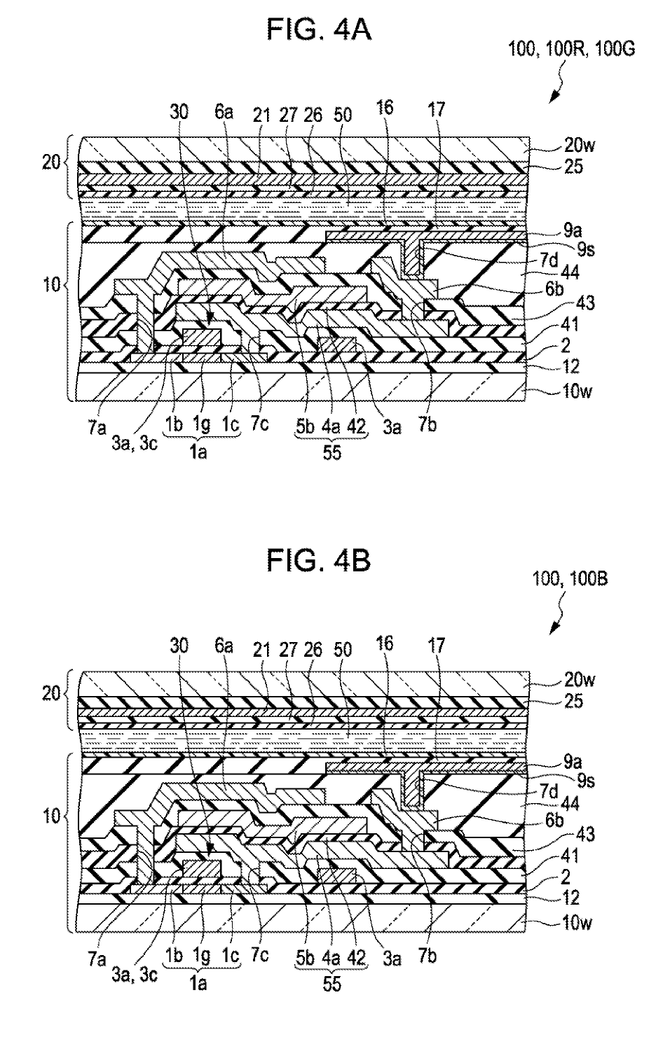

FIG. 3 is a plan view illustrating a pixel of the liquid crystal panel 100 of the projector 1000 according to the embodiment of the invention. In FIG. 3, a semiconductor layer 1a is illustrated by a thin broken line, a scan line 3a is illustrated by a thick solid line, a data line 6a and a thin film formed simultaneously with the data line 6a are illustrated by a chain line, a capacitive line 5b is illustrated by a two-dot chain line, and the pixel electrode 9a is illustrated by a thick broken line, and a lower electrode layer 4a is illustrated by a thin solid line. FIGS. 4A and 4B are sectional views illustrating the pixel of the liquid crystal panel 100 of the projector 1000 according to the embodiment of the invention, taken along line IV-IV of FIG. 3. FIG. 4A illustrates a sectional view of one of the red liquid crystal panel 100R and the green liquid crystal panel 100G, and FIG. 4B illustrates a sectional view of the blue liquid crystal panel 100B.

As illustrated in FIGS. 3 to 4B, in the liquid crystal panel 100, the pixel electrode 9a having a rectangular shape is formed in each of the pixels 100a on the first substrate 10. The data lines 6a and the scan lines 3a extend along vertical and horizontal boundaries between the pixel electrodes 9a, respectively. The data lines 6a and the scan lines 3a each extend linearly, and the pixel transistors 30 are formed in regions in which the data lines 6a intersect the scan lines 3a. The capacitive lines 5b are formed on the first substrate 10 so as to overlap the scan lines 3a. In the present embodiment, each of the capacitive lines 5b includes a main line portion that linearly extends so as to overlap the scan line 3a and a sub-line portion that extends so as to overlap the data line 6a in a region in which the data line 6a intersects the scan line 3a.

As illustrated in FIGS. 4A and 4B, the first substrate 10 includes a substrate body 10w; and the pixel electrode 9a, the pixel transistor 30, and the alignment film 16, which are formed on a surface (a side) of the substrate body 10w facing the liquid crystal layer 50. The substrate body 10w is composed of quartz or glass. The pixel transistor 30 switches the pixel on and off. The second substrate 20 includes a substrate body 20w; and the common electrode 21, and the alignment film 26, which are formed on a surface of the substrate body 20w facing the liquid crystal layer 50 (on a side facing the first substrate 10). The substrate body 20w is composed of quartz or glass, which is light transmissive.

The pixel transistor 30, which includes the semiconductor layer 1a, is formed in the first substrate 10 for each of the pixels 100a. The semiconductor layer 1a includes a channel region 1g, a source region 1b, and a drain region 1c. The channel region 1g faces a gate electrode 3c, which is a part of the scan line 3a, with a gate insulating layer 2 therebetween. Each of the source region 1b and the drain region 1c includes a low density region and a high density region. The semiconductor layer 1a is, for example, a polysilicon film formed on a base insulating film 12 that is a light-transmissive silicon oxide film disposed on the substrate body 10w. The gate insulating layer 2 is a silicon oxide film or a silicon nitride film formed by using a CVD method or the like. The gate insulating layer 2 may have a double-layer structure constituted by a silicon oxide film, which is made by thermally oxidizing the semiconductor layer 1a, and a silicon oxide film or a silicon nitride film, which is made by using a CVD method or the like. An electroconductive polysilicon film, a metal silicide film, or a metal film may be used as the scan line 3a.

A first inter-layer insulation film 41, which is made of a silicon oxide film or the like, is formed on the upper side of the scan line 3a. The lower electrode layer 4a is formed on the upper side of the first inter-layer insulation film 41. The lower electrode layer 4a is substantially L-shaped in that the lower electrode layer 4a extends along the scan line 3a and along the data line 6a from an intersection of the scan line 3a and the data line 6a. The lower electrode layer 4a is made of an electroconductive polysilicon film, a metal silicide film, a metal film, or the like. The lower electrode layer 4a is electrically connected to the drain region 1c via a contact hole 7c.

A dielectric layer 42, which is made of a silicon nitride film or the like, is formed on the upper side of the lower electrode layer 4a. On the upper side of the dielectric layer 42, the capacitive line 5b (an upper electrode layer) is formed so as to face the lower electrode layer 4a with the dielectric layer 42 therebetween. The capacitive line 5b, the dielectric layer 42, and the lower electrode layer 4a constitute a storage capacitor 55. The capacitive line 5b is made of an electroconductive polysilicon film, a metal silicide film, a metal film, or the like.

A second inter-layer insulation film 43, which is made of a silicon oxide film or the like, is formed on the upper side of the capacitive line 5b. The data line 6a and a drain electrode 6b are formed on the upper side of the second inter-layer insulation film 43. The data line 6a is electrically connected to the source region 1b via a contact hole 7a. The drain electrode 6b is electrically connected to the lower electrode layer 4a via a contact hole 7b and electrically connected to the drain region 1c via the lower electrode layer 4a. The data line 6a and the drain electrode 6b are made of an electroconductive polysilicon film, a metal silicide film, a metal film, and the like.

A third inter-layer insulation film 44, which is a silicon oxide film or the like, is formed on the upper side of the data line 6a and the drain electrode 6b. A contact hole 7d, which is connected to the drain electrode 6b, is formed in the third inter-layer insulation film 44. The pixel electrode 9a, which is a reflective electrode made of a reflective metal such as aluminum, is formed on the upper side of the third inter-layer insulation film 44. The pixel electrode 9a is electrically connected to the drain electrode 6b via the contact hole 7d. In the present embodiment, a surface of the third inter-layer insulation film 44 is flat. In the present embodiment, an anti-reflection film 9s, which is a titanium nitride film or the like, is formed on the lower side of the pixel electrode 9a. The anti-reflection film 9s prevents reflection of light on the back side of the pixel electrode 9a, thereby preventing generation of stray light.

The dummy pixel electrode 9b (not shown in FIG. 4), which has been described with reference to FIG. 2B, is formed on the surface of the third inter-layer insulation film 44. The dummy pixel electrode 9b is made of a light transmissive electroconductive film that is formed simultaneously with the pixel electrode 9a.

The alignment film 16 is formed on the surface of the pixel electrode 9a. The alignment film 16 is a resin film, such as a polyimide film, or an obliquely deposited film, such as a silicon oxide film. In the present embodiment, the alignment film 16 is an obliquely deposited inorganic alignment film (vertical alignment film) composed of SiOₓ (x<2), SiO₂, TiO₂, MgO, Al₂O₃, In₂O₃, Sb₂O₃, Ta₂O₅, or the like. A protective film 17, which is a light-transmissive film composed of a silicon oxide or a silicon nitride, is formed between the alignment film 16 and the pixel electrode 9a. The protective film 17 has a flat surface, and recesses formed between the pixel electrodes 9a are filled with the protective film 17. Thus, the alignment film 16 is formed on the flat surface of the protective film 17. In the present embodiment, the alignment film 16 is a double-layer silicon oxide film.

The second substrate 20 includes the substrate body 20w and the common electrode 21. The substrate body 20w is a light transmissive substrate made of quartz or glass. The common electrode 21, which is made of a light transmissive electroconductive film, is formed on a side of the substrate body 20w facing the liquid crystal layer 50 (a side facing the first substrate 10). In the present embodiment, the common electrode 21 is made of a light transmissive electroconductive film, such as an indium tin oxide (ITO) film. The second substrate 20 includes the alignment film 26 that covers the common electrode 21. As with the alignment film 16, the alignment film 26 is made of a resin film, such as a polyimide film, or an obliquely deposited film, such as a silicon oxide film. In the present embodiment, the alignment film 26 is an obliquely deposited inorganic alignment film (vertical alignment film) composed of SiOₓ (x<2), SiO₂, TiO₂, MgO, Al₂O₃, In₂O₃, Sb₂O₃, Ta₂O₅, or the like. A protective film 27, which is composed of a silicon oxide or a silicon nitride, is formed between the alignment film 26 and the common electrode 21. The protective film 27 has a flat surface, and the alignment film 26 is formed on the flat surface. In the present embodiment, the alignment film 26 is a double-layer silicon oxide film. The alignment films 16 and 26 vertically align a nematic liquid crystal of the liquid crystal layer 50, which has negative dielectric anisotropy, so that the liquid crystal panel 100 functions in a normally black VA-mode. A base film 25, which is a silicon oxide film, is formed between the substrate body 20w and the common electrode 21.

### Film Thickness etc. and Spectral Characteristics of Liquid Crystal Panel 100

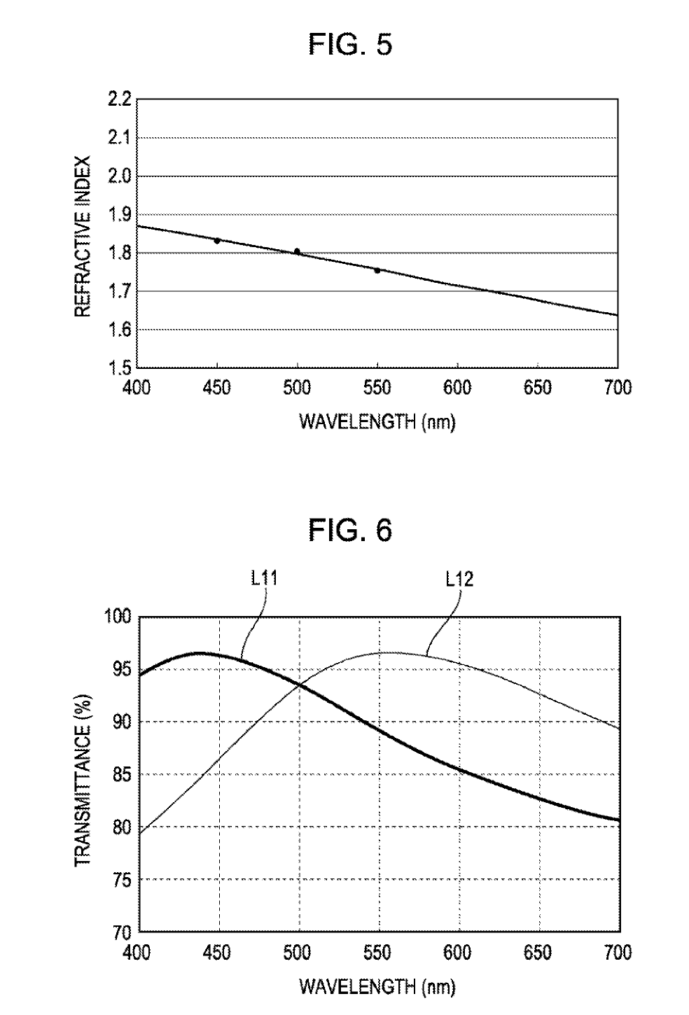

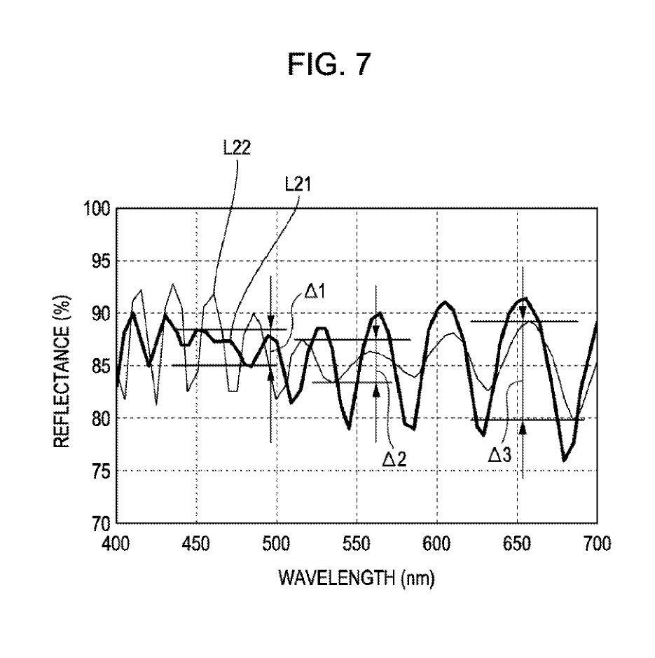

FIG. 5 is a graph illustrating the relationship between the refractive index of an ITO film and the wavelength, the ITO film being used as the common electrode 21 of the liquid crystal panel 100 of the projector 1000 according to the embodiment of the invention. FIG. 6 is a graph illustrating a comparison of the spectral transmission characteristics of the common electrode 21 of the short-wavelength liquid crystal panel (the blue liquid crystal panel 100B) and the common electrodes 21 of other liquid crystal panels (the red liquid crystal panel 100R and the green liquid crystal panel 100G) of the projector 1000 according to the embodiment of the invention. FIG. 7 is a graph illustrating a comparison of the spectral reflection characteristics of the short-wavelength liquid crystal panel (the blue liquid crystal panel 100B) and the other liquid crystal panels (the red liquid crystal panel 100R and the green liquid crystal panel 100G) of the projector 1000 according to the embodiment of the invention.

Among the three liquid crystal panels 100 (the red liquid crystal panel 100R, the green liquid crystal panel 100G, and the blue liquid crystal panel 100B) of the projector 1000 of FIG. 1, the blue liquid crystal panel 100B is the short-wavelength liquid crystal panel, which modulates a light beam in the shortest wavelength range.

In the present embodiment, as can be seen from FIGS. 4A and 4B, the thickness of the common electrode 21 (an ITO film) of the blue liquid crystal panel 100B (the short-wavelength liquid crystal panel) is smaller than the thickness of the common electrode 21 of any one of the other liquid crystal panels (the red liquid crystal panel 100R and the green liquid crystal panel 100G). The thicknesses of the common electrodes 21 (ITO films) of the other liquid crystal panels (the red liquid crystal panel 100R and the green liquid crystal panel 100G) are the same.

Except for the common electrode 21, the films and layers of the liquid crystal panels (the red liquid crystal panel 1008, the green liquid crystal panel 100G, and the blue liquid crystal panel 100B) respectively have the same thicknesses, which are described below.

### First Substrate 10

anti-reflection film 9s (titanium nitride film)

film thickness=50±5 nm

pixel electrode 9a (aluminum film)

film thickness=150±15 nm

protective film 17 (silicon oxide film)

film thickness=325±75 nm
refractive index=1.45 (450 nm), 1.44 (500 nm), 1.44 (550 nm)

lower layer of alignment film 16 (silicon oxide film)

film thickness=32.5±2.5 nm
refractive index=1.60 (450 nm), 1.60 (500 nm), 1.60 (550 nm)

upper layer of alignment film 16 (silicon oxide film)

film thickness=32.5±2.5 nm
refractive index=1.60 (450 nm), 1.60 (500 nm), 1.60 (550 nm)

liquid crystal layer 50

layer thickness=2.1±0.3 μm

### Second Substrate 20

substrate body 20w (quartz)
plate thickness=1.1 mm

base film 25 (boron-phosphorus-doped silicon oxide film)

film thickness=300±30 nm
refractive index=1.50 (450 nm), 1.50 (500 nm), 1.49 (550 nm)

protective film 27 (silicon oxide film)

film thickness=100±15 nm
refractive index=1.42 (450 nm), 1.42 (500 nm), 1.41 (550 nm)

lower layer of alignment film 26 (silicon oxide film)

film thickness=32.5±2.5 nm
refractive index =1.60 (450 nm), 1.60 (500 nm), 1.60 (550 nm)

upper layer of alignment film 26 (silicon oxide film)

film thickness=32.5±2.5 nm
refractive index =1.60 (450 nm), 1.60 (500 nm), 1.60 (550 nm)

In contrast, the film thicknesses of the common electrodes 21 differ between the three liquid crystal panels (the blue liquid crystal panel 100B, the red liquid crystal panel 100R, and the green liquid crystal panel 100G) as described below.

### Short Wavelength Liquid Crystal Panel (Blue Liquid Crystal Panel 100B)

common electrode 21 (ITO film)

film thickness=120±18 nm

refractive index=1.84 (450 nm), 1.80 (500 nm), 1.75 (550 nm)

Other liquid crystal panels 100 (red liquid crystal panel 100R, green liquid crystal panel 100G)

common electrode 21 (ITO film)

film thickness=146±22 nm
refractive index=1.84 (450 nm), 1.80 (500 nm), 1.75 (550 nm)

The film thickness of the common electrode 21 of the short-wavelength liquid crystal panel (blue liquid crystal panel 100B) is in the range of 0.70 to 0.90 times (in this embodiment, 0.82 times) the film thickness of the common electrodes 21 of the other liquid crystal panels (red liquid crystal panel 100R and green liquid crystal panel 100G).

FIG. 5 illustrates the relationship between the wavelength and the refractive index of the ITO film that is used as the common electrode 21 of the liquid crystal panel 100 having the structure described above. Therefore, the relationship between the center wavelength of the wavelength range of a light beam that the liquid crystal panel 100 modulates and the optical film thickness of the common electrode 21 of the liquid crystal panel 100 is as follows.

The optical film thickness (refractive index (1.82)×film thickness (120 nm)) of the common electrode 21 of the blue liquid crystal panel 100B at the center wavelength (465 nm) of a light beam that the blue liquid crystal panel 100B modulates is 218.4 nm, which is about half (0.470 times) the center wavelength (465 nm). Therefore, as illustrated by solid line L11 of FIG. 6, the common electrode 21 of the blue liquid crystal panel 100B has spectral transmission characteristics (which represent the relationship between the wavelength of a light beam supplied to the common electrode 21 and the transmittance of the common electrode 21) having a peak transmittance at 440 nm, which is in the wavelength range (430 to 500 nm) of the light beam that the blue liquid crystal panel 100B modulates.

The optical film thickness (refractive index (1.76)×film thickness (146 nm)) of the common electrode 21 of the green liquid crystal panel 100G at the center wavelength (535 nm) of a light beam that the green liquid crystal panel 100G modulates is 257.0 nm, which is about half (0.480 times) the center wavelength (535 nm). Therefore, as illustrated by solid line L12 of FIG. 6, the common electrode 21 of the green liquid crystal panel 100G has spectral transmission characteristics (which represent the relationship between the wavelength of a light beam supplied to the common electrode 21 and the transmittance of the common electrode 21) having a peak transmittance at 560 nm, which is in the wavelength range (500 to 570 nm) of the light beam that the green liquid crystal panel 100G modulates.

The optical film thickness (refractive index (1.64)×film thickness (146 nm)) of the common electrode 21 of the red liquid crystal panel 100R at the center wavelength (680 nm) of a light beam that the red liquid crystal panel 100R modulates is 239.4 nm, which is deviated from a value of about half (0.447 times) the center wavelength (535 nm). However, as illustrated by solid line L12 of FIG. 6, the common electrodes 21 of the green liquid crystal panel 100G and the red liquid crystal panel 100R have spectral transmission characteristics (which represent the relationship between the wavelength of a light beam supplied to the common electrode 21 and the transmittance of the common electrode 21) having a peak transmittance at 560 nm, which is relatively near the wavelength range (620 to 740 nm) of the light beam that the red liquid crystal panel 100R modulates.

FIG. 7 illustrates the spectral reflection characteristics of the liquid crystal panels 100, which represent the relationship between the reflectance and the wavelength of light beams supplied to the liquid crystal panels 100. In FIG. 7, the thick solid line L21 represents the spectral reflection characteristics of the blue liquid crystal panel 100B (short-wavelength liquid crystal panel), and the thin solid line L22 represents the spectral reflection characteristics of the green liquid crystal panel 100G and the red liquid crystal panel 100R (other liquid crystal panels).

As illustrated by thick solid line L21 of FIG. 7, in the spectral reflection characteristics of the blue liquid crystal panel 100B, the difference Δ1 between the maximum reflectance and the minimum reflectance in the wavelength range (430 to 500 nm) of a light beam that the blue liquid crystal panel 100B modulates is smaller than the difference between the maximum reflectance and the minimum reflectance in a range of wavelength that is longer than wavelength in the range of 430 to 500 nm.

As illustrated by thin solid line L22 of FIG. 7, in the spectral reflection characteristics of the green liquid crystal panel 100G and the red liquid crystal panel 100R (other liquid crystal panels), the difference Δ2 between the maximum reflectance and the minimum reflectance in the wavelength range (500 to 570 nm) of a light beam that the green liquid crystal panel 100G modulates is smaller than the difference between the maximum reflectance and the minimum reflectance in a range of wavelength that is longer than or shorter than wavelength in the range of 500 to 570 nm. In the spectral reflection characteristics of the green liquid crystal panel 100G and the red liquid crystal panel 100R (other liquid crystal panels), the difference Δ3 between the maximum reflectance and the minimum reflectance in the wavelength range (620 to 740 nm) of a light beam that the red liquid crystal panel 100R modulates is larger than the difference between the maximum reflectance and the minimum reflectance in a range of wavelength that is shorter than wavelength in the range of 620 to 740 nm.

Thus, in the present embodiment, the common electrode 21 of the blue liquid crystal panel 100B has a structure corresponding to the wavelength range (430 to 500 nm) of a light beam that the blue liquid crystal panel 100B modulates. Therefore, the blue liquid crystal panel 100B has the spectral reflection characteristics illustrated by thick solid line L21 in FIG. 7. As a result, even if the distance between the first substrate 10 and the second substrate 20 (the layer thickness of the liquid crystal layer 50) of the blue liquid crystal panel 100B has an in-plane variation and the degree of modulation of a light beam in the blue liquid crystal panel 100B is shifted, a blue nonuniform hue is not easily generated in a projected image because the difference Δ1 between the maximum reflectance and the minimum reflectance is small.

The common electrode 21 of the green liquid crystal panel 100G has a structure corresponding to the wavelength range (500 to 570 nm) of the light beam that the green liquid crystal panel 100G modulates. Therefore, the green liquid crystal panel 100G has the spectral reflection characteristics illustrated by thin solid line L22 in FIG. 7. As a result, even if the distance between the first substrate 10 and the second substrate 20 (the layer thickness of the liquid crystal layer 50) of the green liquid crystal panel 100G has an in-plane variation and the degree of modulation of a light beam in the green liquid crystal panel 100G is shifted, a green nonuniform hue is not easily generated in a projected image because the difference Δ2 between the maximum reflectance and the minimum reflectance is small.

However, because the red liquid crystal panel 100R and the green liquid crystal panel 100G has the same structure, the common electrode 21 of the red liquid crystal panel 100R does not have a structure corresponding to the wavelength range (620 to 740 nm) of a light beam that the red liquid crystal panel 100R modulates. Therefore, the red liquid crystal panel 100R has spectral reflection characteristics illustrated by the thin solid line L22 in FIG. 7, in which the difference Δ3 between the maximum reflectance and the minimum reflectance is comparatively large. Nevertheless, because the red liquid crystal panel 100R modulates a light beam having a long wavelength, a red nonuniform hue in a projected image is not conspicuous even if the degree of modulation of the light beam is shifted in the red liquid crystal panel 100R.

### Advantages of Present Embodiment

As described above, in the projector 1000 according to the present embodiment, the film thickness of the common electrode 21 of the blue liquid crystal panel 100B (short-wavelength liquid crystal panel), which is one of the liquid crystal panels 100 that modulates a light beam in the shortest wavelength range, is smaller than the film thickness of the common electrode 21 of any one of the other liquid crystal panels, such as the red liquid crystal panel 100R and the green liquid crystal panel 100G, and the optical film thickness is optimized. Therefore, even if the reflectance of the blue liquid crystal panel 100B increases and decreases with the frequency, the variation range is small. Accordingly, even if there is an in-plane variation in the distance between the first substrate 10 and the second substrate 20 (the layer thickness of the liquid crystal layer 50) of the blue liquid crystal panel 100B and the degree of modulation of light varies from pixel to pixel, variation in the amount of light emitted via the blue liquid crystal panel 100B is small among pixels that are supposed to have the same gradation. As a result, generation of a nonuniform hue due to the in-plane variation in the distance between the first substrate 10 and the second substrate 20 of the blue liquid crystal panel 100B can be prevented.

In the present embodiment, the optical film thickness of the common electrode 21 of the blue liquid crystal panel 100B, which modulates a light beam having a short wavelength, is optimized because the nonuniform hue is easily generated. In contrast, the optical film thicknesses of the common electrodes 21 of other liquid crystal panels (the red liquid crystal panel 100R and the green liquid crystal panel 100G), which modulate light beams having relatively long wavelengths, are made the same because a nonuniform hue is not easily generated. Therefore, the same liquid crystal panels 100 may be used as the red liquid crystal panel 100R and the green liquid crystal panel 100G, whereby generation of a nonuniform hue is prevented while suppressing an increase in the manufacturing cost, as compared with the case where the optical film thickness of the common electrode of each of the liquid crystal panels 100 is optimized.

The film thicknesses of the common electrodes 21 of the other liquid crystal panels (the red liquid crystal panel 100R and the green liquid crystal panel 100G) are set at the same value that is optimal for the green liquid crystal panel 100G, which modulates a light beam having a shorter wavelength. That is, the film thicknesses of the common electrodes 21 of the other liquid crystal panels (the red liquid crystal panel 100R and the green liquid crystal panel 100G) are made the same in such a way that nonuniformities in a green hue and a red hue may not become conspicuous.

Because the ITO film of the common electrode 21 has an refractive index that is higher than those of other layers, the spectral reflection characteristics of the liquid crystal panel 100 can be effectively optimized by adjusting the film thickness of the common electrode 21.

### OTHER EMBODIMENTS

In the embodiment described above, the optical film thickness of the common electrode 21 of the blue liquid crystal panel 100B is optimized. This is because the blue liquid crystal panel 100B serves as the short-wavelength liquid crystal panel among the liquid crystal panels 100, which are the red liquid crystal panel 100R, the green liquid crystal panel 100G, and the blue liquid crystal panel 100B. However, the invention may be applied to a projector including four or more liquid crystal panels 100.

What is claimed is:

1. A projector comprising:
a light source unit;
three or more liquid crystal panels each including a first substrate, a second substrate, and a liquid crystal layer between the first substrate and the second substrate, the first substrate including reflective pixel electrodes formed on a side thereof, the second substrate being light-transmissive and including a common electrode formed on a side thereof facing the side of the first substrate, the common electrode being light-transmissive, each of the three or more liquid crystal panels being supplied with a light beam emitted from the light source unit, the light beams being in different wavelength ranges; and
a projection optical system that projects light generated by combining the light beams modulated by the three or more liquid crystal panels,
wherein the common electrode of a short-wavelength liquid crystal panel, the short-wavelength liquid crystal panel being one of the three or more liquid crystal panels that modulates a light beam in a shortest wavelength range among the three or more liquid crystal panels, has a film thickness that is smaller than a film thickness of the common electrode of any one of the other liquid crystal panels, and
wherein the film thicknesses of the common electrodes of the other liquid crystal panels are the same.

2. The projector according to claim 1,
wherein the short-wavelength liquid crystal panel has spectral reflection characteristics such that a difference between a maximum reflectance and a minimum reflectance in the shortest wavelength range, which is a wavelength range of the light beam that the short-wavelength liquid crystal panel modulates, is smaller than a difference between a maximum reflectance and a minimum reflectance in a range of wavelength that is longer than wavelength of the shortest wavelength range, the spectral reflection characteristics representing a relationship between the wavelength of a light beam supplied to the liquid crystal panel and a reflectance of the liquid crystal panel.

3. The projector according to claim 1,
wherein the film thickness of the common electrode of the short-wavelength liquid crystal panel is in a range of 0.70 to 0.90 times the film thickness of the common electrodes of the other liquid crystal panels.

4. The projector according to claim 3,
wherein an optical film thickness of the short-wavelength liquid crystal panel at a center wavelength of the shortest wavelength range, which is the wavelength range of the light beam that the short-wavelength liquid crystal panel modulates, is about half the center wavelength, the optical film thickness being a product of a refractive index of the common electrode and the film thickness of the common electrode of the short-wavelength liquid crystal panel.

5. The projector according to claim 4,
wherein the optical film thickness of one of the other liquid crystal panels, the one of the other liquid crystal panels modulating a light beam having a shorter wavelength among the other liquid crystal panels, at a center wavelength of the wavelength range of the light beam that the one of the other liquid crystal panels modulates is about half the center wavelength, the optical film thickness being the product of the refractive index of the common electrode and the film thickness of the common electrode of the one of the other liquid crystal panels.

6. The projector according to claim 4,
wherein the common electrode of the short-wavelength liquid crystal panel has spectral transmission characteristics such that a peak transmittance is located in the wavelength range of the light beam that the short-wavelength liquid crystal panel modulates, the spectral transmission characteristics representing a relationship between the wavelength of a light beam supplied to the common electrode and the transmittance of the common electrode.

7. The projector according to claim 1,
wherein the common electrodes of the three or more liquid crystal panels are ITO films.

8. The projector according to claim 1,
wherein the liquid crystal panels are a red liquid crystal panel to which a red light beam is supplied, a green liquid crystal panel to which a green light beam is supplied, and a blue liquid crystal panel to which a blue light beam is supplied,
wherein the blue liquid crystal panel is the short-wavelength liquid crystal panel including the common electrode that has a film thickness smaller than those of the common electrodes of the red liquid crystal panel and the green liquid crystal panel, and
wherein the red liquid crystal panel and the green liquid crystal panel are the other liquid crystal panels including the common electrodes having the same film thickness.

9. An optical unit comprising,
a plurality of liquid crystal panels each including a first substrate, a second substrate, and a liquid crystal layer between the first substrate and second substrate, the first substrate including reflective pixel electrodes formed on a side thereof, the second substrate being light-transmissive and including a common electrode formed on a side thereof facing the side of the first substrate, the common electrode being light-transmissive, each of the plurality of liquid crystal panels being supplied with a light beam, the light beams being in different wavelength ranges; and
a light-combining optical system that emits light generated by combining light beams emitted from the plurality of liquid crystal panel,
wherein the common electrode of a short-wavelength liquid crystal panel, the short-wavelength liquid crystal panels being one of the plurality of liquid crystal panels that modulates a light beam in a shortest wavelength range among the plurality of liquid crystal panels, has a film thickness that is smaller than a film thickness of the common electrode of other liquid crystal panel of the plurality of liquid crystal panels.
